(19) United States
(12) Patent Application Publication
(10) Pub. No.: US 2006/0103104 A1
(43) Pub. Date: May 18, 2006

(54) Coupling device

(76) Inventor: Chun-Mei Kuo, Taipei City (TW)

Correspondence Address: PRO-TECHTOR INTERNATIONAL, 20775 Norada Court, Saratoga, CA, 95070-3018, US

(21) Appl. No.: 10/994,119

(22) Filed: Nov. 18, 2004

(51) Int. Cl. B62B 15/00; B62J 7/00; B62K 27/00

(52) U.S. Cl. 280/202; 280/1

(57) ABSTRACT

A coupling device includes a first fixing member for clamping to a supporting member of a carrying device, and a second fixing member for locking to a rear fork end on a frame of a bicycle. The first and the second fixing member are connected by a first linking member, an elbow, a second linking member, a first union, a third linking member, a second union, a fourth linking member, and first and second height-adjusting members sequentially arranged therebetween, such that the second and the fourth linking member are parallel to each other and perpendicular to the third linking member, enabling the bicycle and the carrying device to move synchronously.

### FIELD OF THE INVENTION

The present invention relates to a coupling device, and more particularly to a coupling device for connecting a carrying device to a bicycle, so that the carrying device and the bicycle move synchronously.

### BACKGROUND OF THE INVENTION

A bicycle, either a foot-pedaled or a power-driven type, has become a basic traffic means in most people's life used when going to school, going to work, shopping, and/or making a trip. The bicycle not only provides more convenience than walking, but also serves as sporting equipment to benefit the bicyclist.

A disadvantage of the bicycle is it does not allow the bicyclist to carry too many things with it. The bicycle is not easily controllable when the bicyclist has to convey multiple bags of things, or handle a baby carriage, a walker, or other loading means while riding on the bicycle. The multiple bags might not be easily stably positioned on the bicycle, and the loading means must be tied to the bicycle using a rope or a chain to synchronously move with the bicycle in the same direction. It is, of course, very dangerous to carry so many things with the bicycle or to tie the loading means to the bicycle for moving synchronously. Moreover, the loading means tied to the bicycle tends to swing sideward while moving along with the bicycle to very possibly result in an unstable bicycle to endanger the bicyclist and near walkers or even cars.

### SUMMARY OF THE INVENTION

It is a primary object of the present invention to provide coupling device that connects a carrying device to a bicycle to form one unit, so that the carrying device and the bicycle move synchronously in the same direction to reduce the possible danger in riding the bicycle.

Another object of the present invention is to provide a coupling device that can be conveniently assembled and disassembled for a user to operate it easily.

To achieve the above and other objects, the coupling device according to the present invention mainly includes a first fixing member for clamping to a supporting bar of a carrying device, a second fixing member for locking to a rear fork end on a frame of a bicycle. The first and the second fixing member are connected by a first linking member, an elbow, a second linking member, a first union, a third linking member, a second union, a fourth linking member, and first and second height-adjusting members sequentially arranged therebetween, such that the second and the fourth linking member are parallel to each other and perpendicular to the third linking member, enabling the bicycle and the carrying device to move synchronously.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a coupling device according to a first embodiment of the present invention;

FIG. 2 is an assembled perspective view of FIG. 1;

FIG. 3 is a vertical sectional view of a first union included in the coupling device of the present invention;

FIG. 4 is a vertical sectional view of a second union included in the coupling device of the present invention;

FIG. 5 is a vertical sectional view showing the first and the second union of the present invention connected via a linking member;

FIG. 6 is an end sectional view of a second fixing member included in the coupling device of the present invention;

FIG. 7 shows a relative position of the coupling device according to the first embodiment of the present invention to a bicycle and a carrying device, wherein the coupling device has not yet been connected to the bicycle and the carrying device;

FIG. 8 is similar to FIG. 7 with the coupling device of the present invention already connected to the bicycle and the carrying device;

FIG. 9 is an exploded perspective view showing a first fixing member and an elbow included in a coupling device according to a second embodiment of the present invention;

FIG. 10 is an assembled perspective view of the coupling device according to the second embodiment of the present invention;

FIG. 11 is an exploded perspective view showing a first fixing member and an elbow included in a coupling device according to a third embodiment of the present invention; and

FIG. 12 is an assembled perspective view of the coupling device according to the third embodiment of the present invention.

### DETAILED DESCRIPTION OF THE PREFERRED EMBODIMENTS

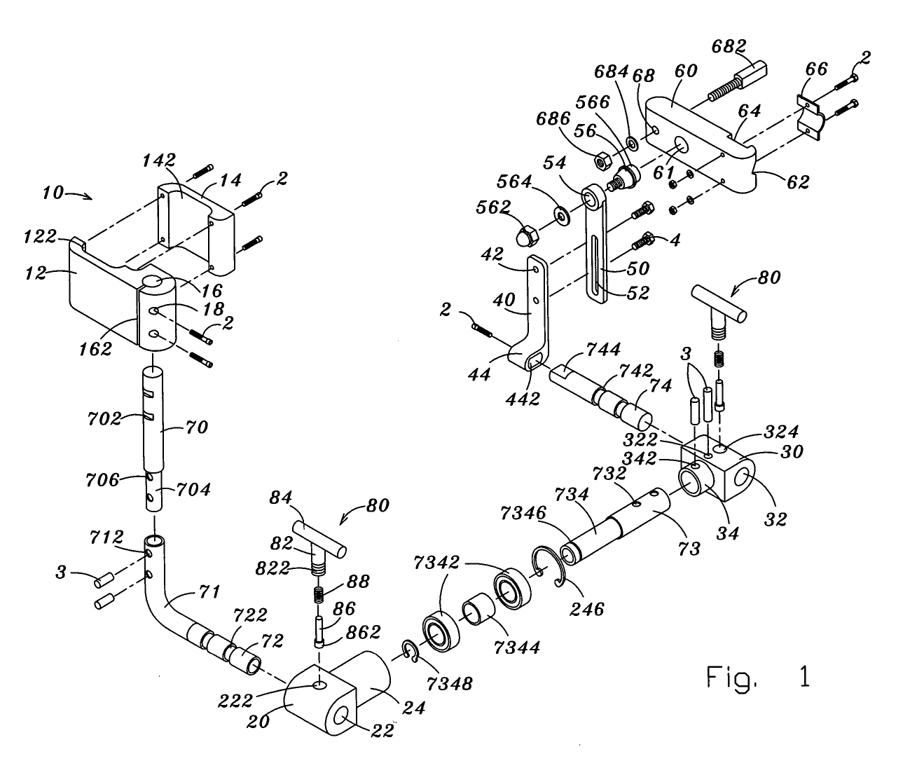

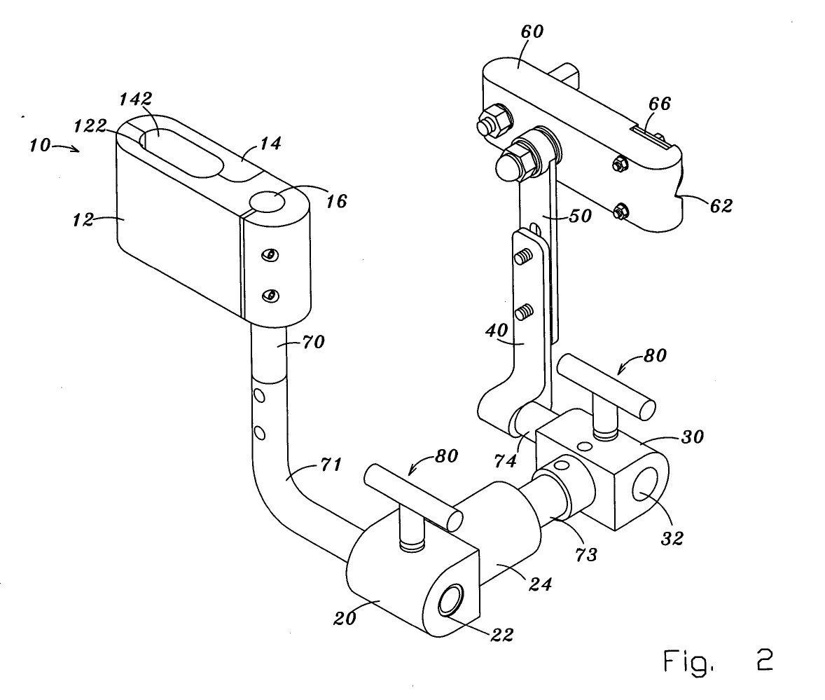

Please refer to FIGS. 1 and 2 that are exploded and assembled perspective views, respectively, of a coupling device according to a first embodiment of the present invention. As shown, the coupling device according to the present invention mainly includes a first fixing member 10, a first union 20, a second union 30, a first height-adjusting member 40, a second height-adjusting member 50, a second fixing member 60, and a plurality of linking members.

The first fixing member 10 consists of a primary block 12 and a complementary block 14 correspondingly attachable to an inner side of the primary block 12 closer to a first end of the first fixing member 10 using a plurality of screw bolts 2. Vertically extended clamping recesses 122, 142 are symmetrically formed at inner sides of the primary and the complementary block 12, 14, respectively, to clamp a vertical straight member (not shown in FIGS. 1 and 2) therebetween. The primary block 12 is provided with an axial hole 16 vertically extended through a second end opposite to the first end thereof. A slit 162 is formed between an inner surface of the axial hole 16 and an outer side of the second end of the primary block 12, and a plurality of horizontally extended threaded holes 18 are vertically spaced on the second end of the primary block 12 corresponding to the slit 162.

A first linking member 70 having a plurality of vertically spaced locating notches 702 corresponding to the spaced threaded holes 18 is upward extended at a first end into the axial hole 16, and is firmly retained in the axial hole 16 by screw bolts 2 extended into the threaded holes 18 to engage with the locating notches 702 and tighten the slit 162. An opposite or second end of the first linking member 70 is formed into a diameter-reduced fixing end 704 that extends a predetermined length and is provided with a plurality of vertically spaced stopper pin holes 706. An elbow 71 is fixedly connected to the first linking member 70 by putting a first end of the elbow 71 on the second end of the first linking member 70 and threading a plurality of stopper pins 3 through stopper pin holes 712 provided on the first end of the elbow 71 into stopper pin holes 706 on the second end of the first linking member 70. A second linking member 72 is connected at a first end to a second end of the elbow 71, and is provided at predetermined positions with a plurality of axially spaced annular locating grooves 722.

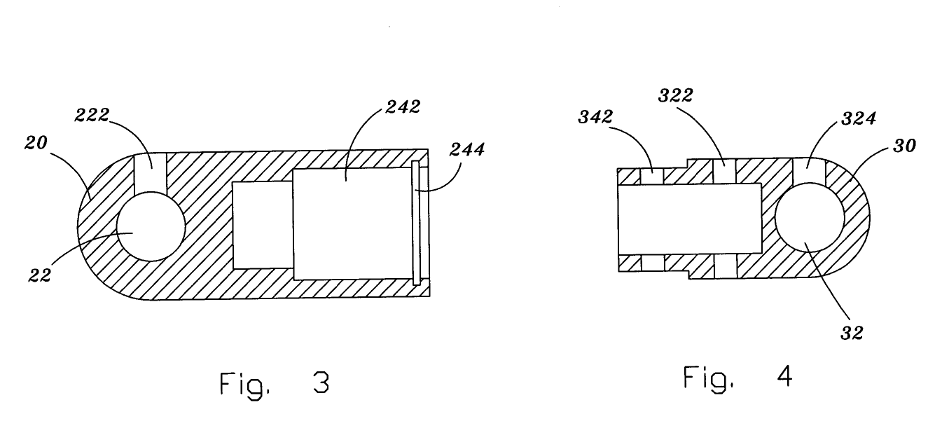

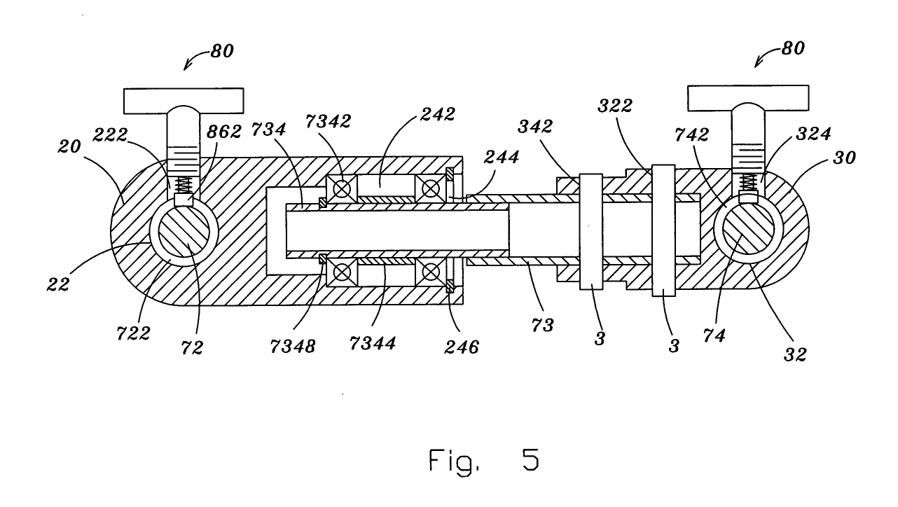

Please refer to FIGS. 1, 3, 4, and 5. The first union 20 is provided with a horizontally extended axial hole 22, into which a second end of the second linking member 72 is extended, and includes a sleeve portion 24 sideward extended from an inner side of the first union 20 by a predetermined length. A threaded hole 222 is provided on a top of the first union 20 to extend in a direction normal to the axial hole 22 and communicate with the axial hole 22 for a first locking member 80 to downward screw thereinto.

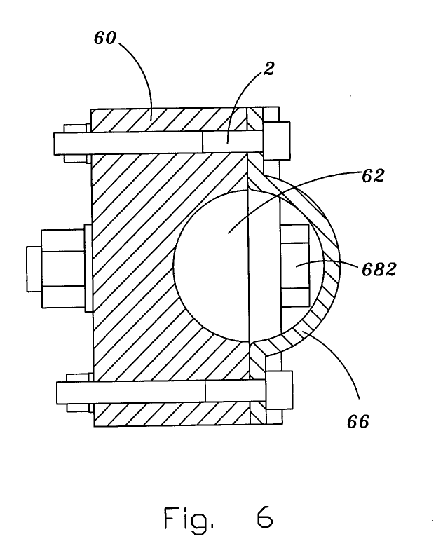

The first locking member 80 includes a vertical tubular portion 82, and a horizontal handle 84 connected to a top of the tubular portion 82. A lower end of the tubular portion 82 is formed into an externally threaded section 822 for screwing into the threaded hole 222 on the first union 20. A locking pin 86 having an expanded lower end 862 is received in the tubular portion 82 with a compression spring 88 put around the locking pin 86. Please refer to FIGS. 1 and 5. When the first locking member 80 is screwed into the threaded hole 222 on the first union 20 with the expanded lower end 862 fitly engaged with one of the annular locating grooves 722 on the second linking member 72, the second linking member 72 is firmly retained at the second end thereof to the axial hole 22 of the first union 20 without the risk of easily separating therefrom.

The sleeve portion 24 of the first union 20 receives a first end of a third linking member 73 therein. The third linking member 73 is provided at an opposite or second end with a plurality of horizontally spaced stopper pin holes 732. The first end of the third linking member 73 is formed into a diameter-reduced extension 734, around which two bearings 7342 spaced by a collar 7344 are sequentially mounted. Alternatively, it is also possible to have only one bearing 7342 mounted around the diameter-reduced extension 734. In this case, the one single bearing 7342 shall have a length depending on a length of a bore 242 of the sleeve portion 24, which will be mentioned latter. An annular locking groove 7346 is externally provided near an outer end of the extension 734 for a C-ring 7348 to engage therewith and thereby prevents the bearings 7342 and the collar 7344 from moving out of the outer end of the extension 734. As can be clearly seen from FIG. 5, the bearings 7342 on the extension 734 of the third linking member 73 are located in and circumferentially in contact with a bore 242 of the sleeve portion 24 of the first union 20, and an annular groove 244 is provided around an inner surface of the bore 242 close to an open end of the sleeve portion 24 for receiving a C-ring 246 therein, so as to prevent the diameter-reduced extension 734 of the third linking member 73 and the bearings 7342 mounted on the extension 734 from easily separating from the bore 242.

The second union 30 is provided with a horizontally extended axial hole 32 for receiving a second end of a fourth linking member 74 therein, and includes a sleeve portion 34 sideward extended from an inner side of the second union 30 for the second end of the third linking member 73 to extend thereinto. The second union 30 and the sleeve portion 34 are provided with a stopper pin hole 322, 342 each corresponding to the stopper pin holes 732 on the second end of the third linking member 73. The second end of the third linking member 73 is firmly received in the sleeve portion 34 and connected to the second union 30 by stopper pins 3 down ward extended through the stopper pin holes 322, 342 into the stopper pin holes 732. The second union 30 is also provided at a top with a threaded hole 324 vertically extended in a direction normal to the axial hole 32 for a second locking member 80, which is identical to the first locking member 80, to screw thereinto.

The second end of the fourth linking member 74 is provided with a plurality of horizontally spaced annular locating grooves 742. When the second locking member 80 is screwed into the threaded hole 324 with the expanded lower end 862 of the locking pin 86 fitly engaged with one of the annular locating grooves 742 on the second end of the fourth linking member 74, the fourth linking member 74 is firmly retained at the second end to the axial hole 32 of the second union 30 without the risk of easily separating therefrom. An opposite or first end of the fourth linking member 74 is formed into a flat fixing end 744.

The first height-adjusting member 40 is an elongated flat plate having a plurality of screw holes 42 vertically spaced thereon, and includes a sideward expanded lower end 44 having a horizontally extended connecting hole 442 for fitly receiving the flat fixing end 744 of the fourth linking member 74 therein. A screw bolt 2 is extended through a screw hole (not shown) formed on a closed bottom of the connecting hole 442 to lock the flat fixing end 744 of the fourth linking member 74 to the lower end of the first height-adjusting member 40.

The second height-adjusting member 50 is an elongated flat plate provided with a vertical long slot 52, via which a plurality of screw bolts 4 are extended to engage with the screw holes 42 on the first height-adjusting member 40 and thereby connect the first and the second height-adjusting members 40, 50 together while allowing the second height-adjusting member 50 to move relative to the first height-adjusting member 40 along the long slot 52. An upper end of the second height-adjusting member 50 is formed into a round through hole 54 for a threaded end of a conical bolt 56 to forward extend therethrough to engage with a washer 564 and a screw cap 562 and be locked in place.

Please refer to FIGS. 1, 2, and 6. The second fixing member 60 is a substantially horizontally extended rectangular block with an outer side provided with a horizontal channel 62 and a pair of upper and lower recess 64. When a hold-down bracket 66 is screwed to an outer side of the upper and lower recesses 64 with screw bolts 2, a horizontal member, such as a tube or a bar (not shown), can be firmly locked in the horizontal channel 62. The second fixing member 60 is provided at a predetermined position with a through hole 68 for a fixing bolt 682 to extend therethrough to engage with a washer 684 and a nut 686 and be locked in place, and at an inner side with a mounting hole 61 for firmly receiving a fixing end 566 of the conical bolt 56 opposite to the threaded end thereof, so that the second height-adjusting member 50 is fixedly connected to the second fixing member 60.

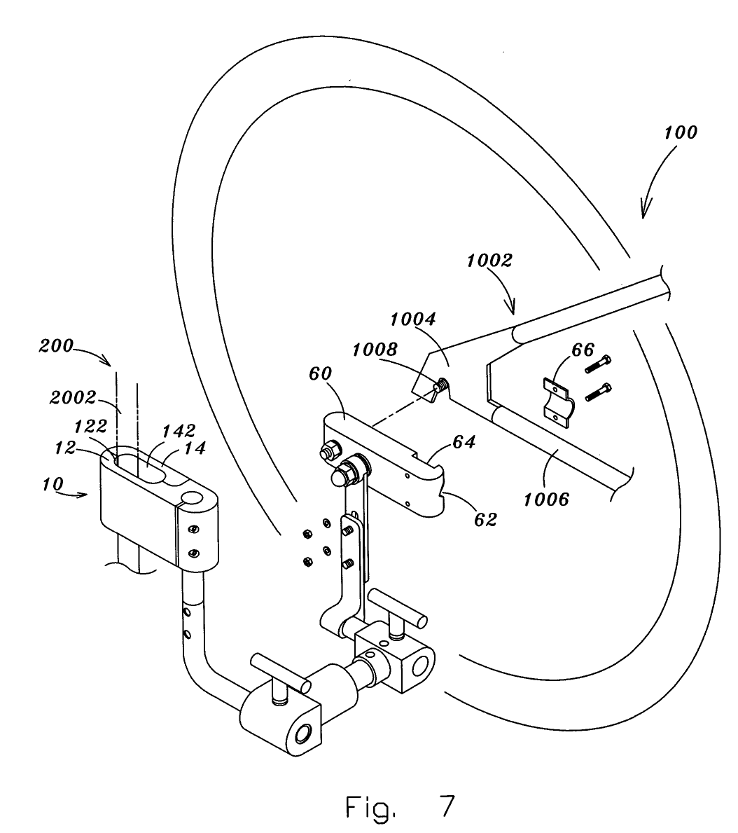

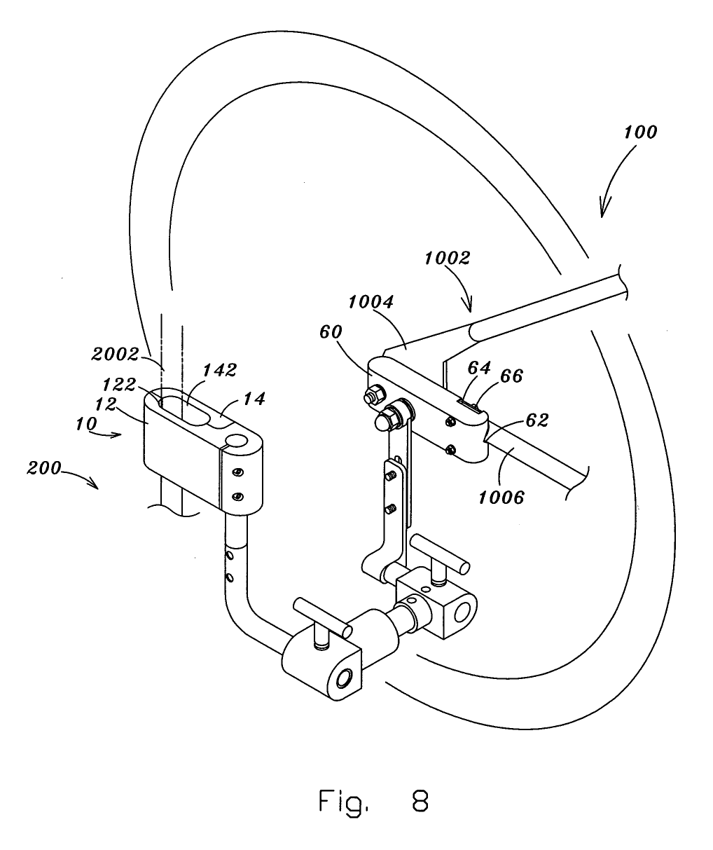

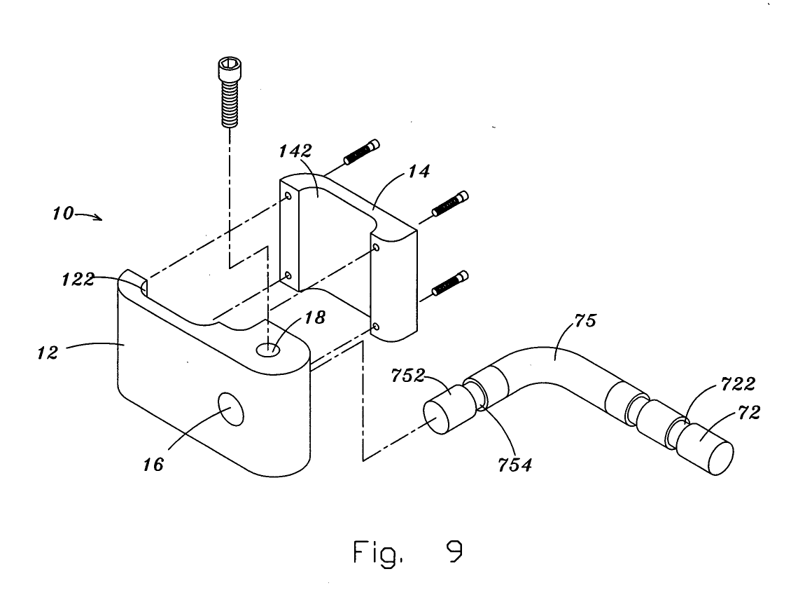

FIGS. 7 and 8 shows the connection of a foot-pedaled bicycle or a power-driven bicycle 100 to a carrying device 200 via the coupling device of the first embodiment of the present invention, so that the carrying device 200 and the bicycle 100 moves synchronously. The carrying device 200 may be, for example, a baby carriage, another bicycle, or a walker. In the first embodiment of the present invention, the second fixing member 60 is designed mainly for fixing to a fork end 1004 at a lower end of a seat stay 1002 of the bicycle 100. To do this, simply align the horizontal channel 62 on the second fixing member 60 with a chain stay 1006 forward and horizontally extended from the fork end 1004, connecting the hold-down bracket 66 to the upper and lower recesses 64 to firmly hold the chain stay 1006 to the channel 62, and screwing the fixing bolt 682 to a threaded rod 1008 connected to a rear hub (not shown) of the bicycle 100. On the other hand, the first fixing member 10 is designed mainly for connecting to a vertical supporting post 2002 on a main frame (not shown) of the carrying device 200. To do so, simply clamp the vertical supporting post 2002 in the closed clamping recesses 122, 142 between the primary and the complementary block 12, 14, and lock the complementary block 14 to the primary block 12 using screw bolts 2.

The first and the second fixing member 10, 60 are then connected together via the first linking member 70, the elbow 71, the second linking member 72, the first union 20, the third linking member 73, the second union 30, the fourth linking member 74, and the first and the second height-adjusting member 40, 50. Wherein, the second and the fourth linking member 72, 74 are horizontally parallel with each other, and perpendicular to the third linking member 73. In this manner, the bicycle 100 in moving would bring the carrying device 200 to move synchronously for conveniently carrying some necessary things.

Since the first and the second union 20, 30 are connected via the third linking member 73 and the bearings 7342 mounted thereon, the first union 20 is rotatable relative to the second union 30. Whereby, when the bicycle 100 is moving on a rough road, the rotatable connection of the first union 20 to the second union 30 prevents the bicycle 100 and the carrying device 200 coupled to each other via the coupling device of the present invention from mutually interfering with each other.

Meanwhile, when the carrying device 200 is located at a height different from the fork end 1004 of the bicycle 100, the first and the second union 20, 30 could be kept at the same level for the third linking member 73 to always be parallel with the road surface simply by moving the first height-adjusting member 40 in the long slot 52 relative to the second height-adjusting member 50 to a desired vertical position.

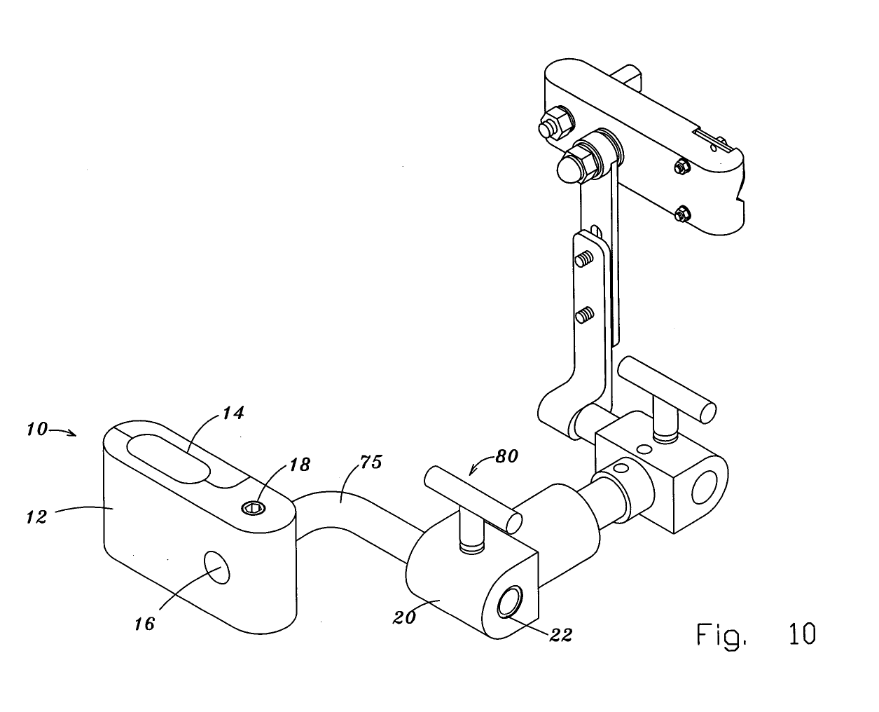

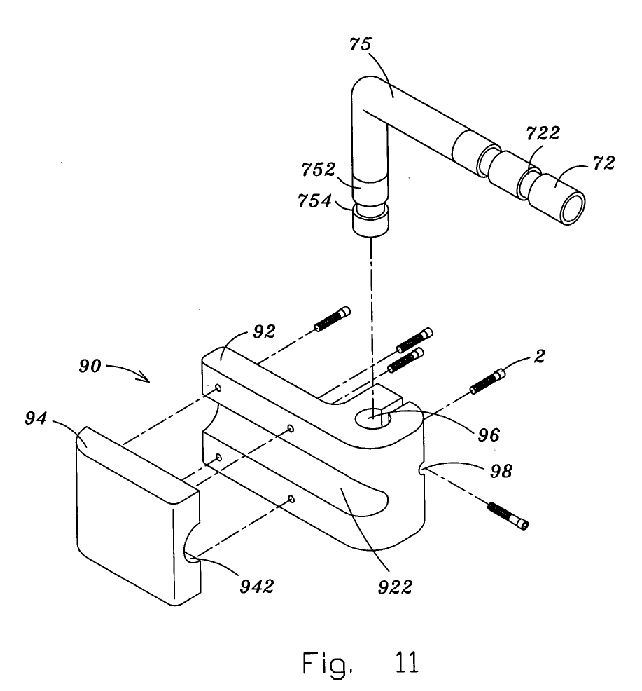

For the coupling device of the present invention to adapt to firm connection to various kinds of carrying devices, it is necessary for the first fixing member 10 to have different configurations. FIGS. 9 and 10 shows a coupling device according to a second embodiment of the present invention. In the second embodiment, the first fixing member 10 is structurally similar to that in the first embodiment, except that the primary block 12 is provided at the second end with a horizontally extended axial hole 16 for a fifth linking member 752 connected to a first end of an elbow 75 to extend thereinto, and a vertically extended threaded hole 18 perpendicular to and communicating with the axial hole 16 for a screw bolt 2 to screw thereinto. The screw bolt 2 in the threaded hole 18 engages with an annular locating groove 754 on the fifth linking member 752 to prevent the latter from easily separating from the horizontal axial hole 16. An opposite or second end of the elbow 75 is connected to the second linking member 72 for horizontally locating in the axial hole 22 of the first union 20, just as in the first embodiment. The first fixing member 10 and the elbow 75 in the coupling device of the second embodiment are suitable for clamping to the vertical supporting post 2002 of the carrying device 200 at a point closer to the road surface, as shown in FIG. 10.

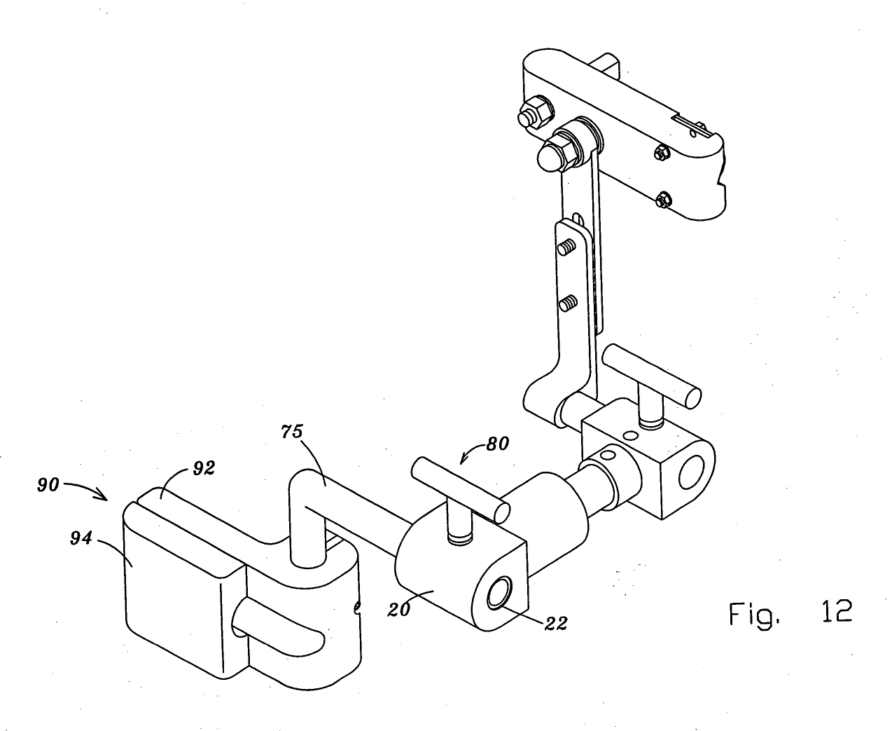

FIGS. 11 and 12 shows a coupling device according to a third embodiment of the present invention. The third embodiment is structurally similar to the first embodiment, except that it includes a first fixing member 90 consisting of a primary block 92 and a complementary block 94, and a fifth linking member 752 connected at a second end to a first end of an elbow 75. The complementary block 94 is correspondingly attachable to an outer side of the primary block 92 closer to a first end of the first fixing member 90 using a plurality of screw bolts 2. Horizontally extended clamping recesses 922, 942 are correspondingly formed at outer and inner side of the primary and the complementary block 92, 94, respectively, to clamp a horizontal straight member (not shown in FIGS. 1 and 2) therebetween. The primary block 92 is provided with an axial hole 96 vertically extended through a second end opposite to the first end thereof, and a horizontal threaded hole 98 normal to and communicating with the axial hole 96. The fifth linking member 752 is extended into and retained in the axial hole 96 on the primary block 92 of the first fixing member 90 by screwing a screw bolt 2 through the threaded hole 98 into the axial hole 96 to engage with an annular locating groove 754 formed on an opposite or first end of the fifth linking member 752. The first fixing member 90 is designed mainly for clamping to a horizontal member 2002 on the carrying device 200, as shown in FIG. 12.

The coupling device of the present invention has the following advantages:
1. By connecting the first and the second fixing member to the carrying device and the bicycle, respectively, the carrying device forms a part of the bicycle to synchronously move with the bicycle in the same direction. Therefore, some necessary articles on the carrying device 200 could be transported using the bicycle.

2. The whole coupling device are assembled using removable screw bolts, locking pins, and stopper pins, and can therefore be easily disassembled. That is, the first and the second union could be easily connected to or separated from the second and the fourth linking member to facilitate quick connection or disconnection of the first fixing member to or from the second fixing member. In other words, the coupling device of the present invention provides great convenience in operation thereof, and a bicyclist could easily decide whether to connect the carrying device to the bicycle or replace the carrying device with some other suitable carrying means for moving them with the bicycle synchronously.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A coupling device, comprising:
a first fixing member consisting of a primary and a complementary block, said complementary block being correspondingly attachable to one lateral side of said primary block closer to a first end of said first fixing member using a plurality of screw bolts;
two clamping recesses being symmetrically formed at two opposite sides of said primary and said complementary block facing each other to clamp a straight member therebetween; and said primary block being provided at a predetermined position closer to a second end thereof with an axial hole;
a first union being provided with a horizontally extended axial hole for receiving a second end of a second linking member, and including a sideward extended sleeve portion for receiving a first end of a third linking member; said second linking member being connected at a first end to a second end of an elbow, said elbow being connected at a first end to a second end of a first linking member, and a first end of said first linking member being received in said axial hole provided on said primary block of said first fixing member; said first end of said third linking member being a diameter-reduced extension having at least one bearing mounted thereon, such that said at least one bearings is located in a bore of said sleeve portion of said first union;
a second union being provided with a horizontally extended axial hole for receiving a second end of a fourth linking member therein, and including a sideward extended sleeve portion for receiving a second end of said third linking member therein;
and said fourth linking member having a second end opposite to said first end being formed into a flat fixing end;
a first height-adjusting member being an elongated flat plate having a plurality of screw holes vertically spaced thereon, and including a sideward expanded lower end having a horizontally extended connecting hole; and said flat fixing end or second end of said fourth linking member being received in and locked to said connecting hole by a screw bolt extended through a screw hole formed on a closed bottom of said connecting hole;
a second height-adjusting member being an elongated flat plate provided with a vertical long slot, via which a plurality of screw bolts are extended to engage with said screw holes vertically spaced on said first height-adjusting member and thereby connect said first and said second height-adjusting members together while allowing said second height-adjusting member to move relative to said first height-adjusting member along said long slot;
said second height-adjusting member being formed at an upper end with a round through hole for a threaded end of a conical bolt to forward extend therethrough to engage with a washer and a screw cap and be locked in place; and
a second fixing member being a substantially horizontally extended rectangular block with an outer side provided with a channel and a pair of upper and lower recess; a hold-down bracket being screwed to an outer side of said upper and lower recesses with screw bolts, so as to hold a straight member in said channel; said second fixing member being provided at an inner side with a mounting hole for firmly receiving a fixing end of said conical bolt opposite to said threaded end thereof, so that said second height-adjusting member is fixedly connected to said second fixing member.

2. The coupling device as claimed in claim 1, wherein said axial hole provided at the second end of said primary block of said first fixing member is vertically extended, and wherein said primary block is provided at the second end between an inner surface of said axial hole and an outer side of said primary block with a slit, and at positions corresponding to said slit with a plurality of horizontally extended and vertically spaced screw holes.

3. The coupling device as claimed in claim 1, wherein said first union is provided at a top with a threaded hole normal to and communicating with said horizontal axial hole on said first union for a first locking member to downward screw thereinto to engage with an annular locating groove provided on the second end of said second linking member, which is extended into said horizontal axial hole of said first union.

4. The coupling device as claimed in claim 1, wherein said third linking member is provided at the second end with a plurality of stopper pin holes, and wherein said second union and said sleeve portion thereof are provided with a stopper pin hole each correspondingly to said stopper pin holes on the second end of said third linking member for stopper pins to extend thereinto to firmly connect the second end of said third linking member to said sleeve portion of said second union.

5. The coupling device as claimed in claim 1, wherein said diameter-reduced extension has two bearings sequentially mounted therearound, and said two bearings are spaced by a collar.

6. The coupling device as claimed in claim 1, wherein said diameter-reduced extension of said third linking member is provided close to an outer end with an annular locking groove for a C-ring to engage therewith.

7. The coupling device as claimed in claim 1, wherein said sleeve portion of said first union is provided around an inner surface of said bore close to an open end thereof with an annular groove for receiving a C-ring therein, so as to prevent said diameter-reduced extension of said third linking member and said bearings mounted on said extension from separating from said bore of said sleeve portion.

8. The coupling device as claimed in claim 1, wherein said second union is provided at a top with a threaded hole normal to and communicating with said horizontal axial hole provided on said second union for a second locking member to downward screw thereinto to engage with one annular locating groove provided on the second end of said fourth linking member.

9. The coupling device as claimed in claim 3, wherein said first locking member includes a vertical tubular portion, and a horizontal handle connected to a top of said tubular portion; a lower end of said tubular portion being formed into an externally threaded section for screwing into said threaded hole on the top of said first union; and a locking pin having an expanded lower end being received in said tubular portion with a compression spring put around said locking pin; whereby when said first locking member is downward screwed into said threaded hole on said first union, said expanded lower end of said locking pin is fitly engaged with one of said annular locating grooves on the second end of said second linking member.

10. The coupling device as claimed in claim 8, wherein said second locking member includes a vertical tubular portion, and a horizontal handle connected to a top of said tubular portion; a lower end of said tubular portion being formed into an externally threaded section for screwing into said threaded hole on the top of said second union; and a locking pin having an expanded lower end being received in said tubular portion with a compression spring put around said locking pin; whereby when said second locking member is downward screwed into said threaded hole on said second union, said expanded lower end of said locking pin is fitly engaged with one of said annular locating grooves on the second end of said fourth linking member.

11. The coupling device as claimed in claim 1, wherein said channel provided on said second fixing member is a horizontal channel.

12. The coupling device as claimed in claim 1, wherein said second fixing member is provided at a predetermined position with a through hole for a fixing bolt to extend therethrough to engage with a washer and a nut and be locked in place.

13. The coupling device as claimed in claim 1, wherein said clamping recesses provided on said primary and said complementary block of said first fixing member are extended vertically.

14. The coupling device as claimed in claim 2, wherein said clamping recesses provided on said primary and said complementary block of said first fixing member are extended horizontally.

15. The coupling device as claimed in claim 1, wherein said axial hole provided on said primary block of said first fixing member is vertically extended.

16. The coupling device as claimed in claim 1, wherein said axial hole provided on said primary block of said first fixing member is horizontally extended.
